(19) United States
(12) Patent Application Publication
(10) Pub. No.: US 2026/0192600 A1
(43) Pub. Date: Jul. 9, 2026

(54) REFURBISHED STEERABLE DRIVE AXLE ASSEMBLY DERIVED FROM A MILITARY DRIVE AXLE

(71) Applicant: Custom Truck One Source, Inc., Kansas City, MO (US)

(72) Inventor: Dean Smith, Kansas City, MO (US)

(73) Assignee: Custom Truck One Source, Inc., Kansas City, MO (US)

(21) Appl. No.: 19/439,605

(22) Filed: Jan. 5, 2026

Related U.S. Application Data
(60) Provisional application No. 63/742,046, filed on Jan. 6, 2025.

(51) Int. Cl. B60B 35/00

(52) U.S. Cl. CPC B60B 35/003; B60B 2900/541

(57) ABSTRACT

A method and apparatus are provided for refurbishing surplus military drive axles for use on commercial vehicles. A surplus military used axle is disassembled, inspected, and upgraded to meet commercial operational and safety standards. Fixed drive ends are removed and replaced with steerable ends supported by bearings or bushings and actuated by a steering mechanism connected to a steering control system of the commercial vehicle. The refurbished axle is equipped with disc brakes, an anti-lock braking system (ABS), and a traction control system (TCS). A speed monitoring system automatically centers and locks a rear steer axle at or above a designated road speed to enhance high-speed stability. An all-wheel steering system coordinates front and rear steering, including crab steering and operator-controlled rear steering, to improve maneuverability. The refurbished axle may include corrosion-resistant finishes, adapted wheel hubs, and re-geared differentials for commercial applications.

### CROSS REFERENCE TO RELATED APPLICATIONS

This application claims the benefit of priority to U.S. Provisional Patent Application No. 63/742,046, filed Jan. 6, 2025, the entire disclosure of which is hereby incorporated by reference.

### FIELD OF USE

The present disclosure relates generally to heavy-duty vehicle axles and steering systems, and more particularly to methods and assemblies, for refurbishing surplus military drive axles and adapting them for use on commercial vehicles to include, among others, construction trucks, refuse-collection vehicles, utility service trucks, tow-and-recovery vehicles, snow-removal vehicles, and concrete-delivery trucks.

### BACKGROUND

Heavy-duty commercial vehicles are commonly operated in confined environments such as urban streets, alleys, job sites, and work zones. These vehicles often require enhanced maneuverability and reduced turning radius to safely navigate narrow spaces, avoid obstacles, and align with work locations. Conventional fixed drive axles used on many heavy-duty commercial vehicles can limit maneuverability, particularly when the vehicles are equipped with long wheelbases or additional equipment such as aerial lifts, snowplows, or mixer drums.

Surplus military vehicles frequently incorporate robust drive axles that are designed to withstand high loads and harsh operating environments. These axles may be available as surplus components when military vehicles are retired or repurposed. However, military drive axles are generally configured with fixed drive ends and are designed for specific military vehicle platforms and mounting arrangements. As a result, surplus military axles are not directly suitable for installation on commercial vehicles without substantial modification, particularly where steerable axles, coordinated steering, and modern braking, and traction control systems are required.

There is a need for improved methods of refurbishing surplus military drive axles and adapting them for use in commercial vehicle applications. There is also a need for refurbished axle assemblies and vehicle systems that incorporate such assemblies, including systems that provide coordinated all-wheel steering, speed-dependent control of rear steer axles, and integration with anti-lock braking systems (ABS) and traction control systems (TCS) to meet applicable safety and performance standards for commercial vehicles.

### SUMMARY

In one aspect, a method is provided for refurbishing a surplus military drive axle for use on a commercial vehicle. The method includes obtaining a surplus military axle originally configured for a military-grade vehicle, assessing structural integrity and wear of axle components, disassembling the axle, and inspecting individual components for wear and damage. Damaged components are repaired or replaced to satisfy commercial vehicle operational standards.

At least one of the axle housing and a differential is modified to fit mounting systems of a commercial vehicle. The axle is converted from fixed drive ends to a pair of steerable ends by removing the fixed drive ends, performing a load-distribution analysis, installing a steering mechanism and steering actuators, and providing mounting points and bearings or bushings for steerable knuckles.

In some embodiments, the refurbished axle assembly is adapted to interface with standard commercial vehicle wheels rather than the wheel and hub interfaces associated with the original military-grade application. To that end, the refurbishment process may include modifying or replacing one or more hub-related components so that the axle assembly presents a commercially compatible wheel mounting interface, including a selected bolt circle diameter and a selected offset corresponding to commercially available wheel and rim configurations. In this context, “bolt circle diameter” refers to the diameter of the circle passing through the centers of the wheel mounting studs or bolt holes, and “offset” refers to the axial spacing between the wheel mounting surface and a wheel centerline. By selecting the bolt circle diameter and offset to match a target commercial wheel specification, the refurbished axle assembly can accept standard commercial wheels without the need for custom wheel adapters, thereby simplifying integration into commercial chassis platforms and facilitating serviceability using readily available replacement wheels.

There are at least four modes of operation of steerable axles on a vehicle to include straight truck conventional steering with the rear centered and locked. This is the “normal driving” configuration: the vehicle steers conventionally (front axle steers; rear steer axle(s) are inhibited and held centered). This disclosure describes a mode where the controller achieves “conventional steering” behavior and, at higher speeds, limits or disables rear steer authority. This mode is most preferred when road/highway travel and higher-speed operation, where stability and predictable handling dominate.

This mode is also used any time the vehicle is heavily loaded, or stability margins must be maximized, especially if interlocks restrict rear steering based on payload/configuration (e.g., aerial lift extended, concrete drum full, towing). Lastly, fail-safe/degraded operation for when a fault is detected, the system can transition to a safe centered-axle state (conceptually consistent with using this as the default “safe” mode).

The next mode is a coordinated mode with all steerable axles coordinated by stored steering. In this mode, an all-wheel steering control unit coordinates front and rear steering angles using stored steering profiles and inputs such as steering wheel angle and vehicle speed. The control logic can command rear steer in-phase or counter-phase at very low speeds, then progressively reduce authority with speed. This mode is most preferred with general low-speed maneuvering where the goal is “best overall” turning performance without requiring the operator to manually manage rear steer.

The system can automatically choose appropriate relationships (including counter-phase for tight turns) at very low speeds. Applications include stop-and-go urban duty cycles (e.g., refuse collection), where calibrated profiles keep rear steer active at typical collection speeds but still lock it out above a threshold between stops/arterials. Application-specific configurations (snowplow deployed, towing, aerial lift truck), where the controller can enforce interlocks and reduce rear steer authority when stability is critical.

The third mode is the crab walk mode or crab steering. Crab mode steers the front and rear axles in the same angular direction relative to the vehicle's longitudinal axis. The disclosure highlights that crab steering facilitates lateral movement and repositioning in confined spaces. This mode is preferred when moving the vehicle sideways to align with a dock, trench, curb line, or work location without requiring multi-point turns. Tight, obstacle-rich job sites where forward turning is possible but inefficient (e.g., equipment staging areas, narrow alleys, crowded yards).

The fourth mode is manual override mode also known as operator controlled rear steer. This is explicitly described as an operator-controlled rear steering mode in which the driver interface allows the operator to independently adjust rear wheel steering angle relative to the front axle steering angle. This mode is preferred during precision low-speed maneuvers where the operator wants “hands-on” control to place the rear of the vehicle exactly where needed (backing into docks, threading through gates, aligning a boom/winch body, positioning near obstacles). The disclosure ties this mode to significantly reduced turning radius and tight job-site maneuvers to include specialty operations where the operator is actively managing vehicle articulation/placement (e.g., tow-and-recovery positioning, staged approaches on uneven surfaces), and a skilled operator benefits from direct rear steering authority (while still subject to speed-dependent lockout).

The steering control system of the commercial vehicle is integrated with the refurbished axle so that an operator can control steering movement of the steerable ends from a driver position. The method further includes aligning steering and suspension components, reassembling the axle, applying a corrosion-resistant finish, installing disc brakes, integrating an ABS sensor, providing a TCS, installing a speed monitoring system that automatically centers and locks a rear steer axle at or above a designated road speed, and providing an all-wheel steering system capable of coordinating crab steering and operator-controlled rear steering.

In another aspect, a refurbished axle assembly is provided that is adapted from a surplus military drive axle for use on a commercial vehicle. The axle assembly includes a reworked axle housing, a differential, a pair of steerable ends replacing original fixed drive ends, a steering mechanism, at least one steering actuator, disc brake assemblies, an ABS with wheel-speed sensors, a TCS coupled to the ABS, a speed monitoring system configured to automatically center and lock a rear steer axle at or above a designated road speed, an all-wheel steering system configured to coordinate front and rear axle steering, and a corrosion-resistant finish applied to the axle housing. Optional features may include dynamically balanced axle shafts and wheel hubs adapted to receive standard commercial vehicle wheels.

In a further aspect, a commercial vehicle is provided that includes a vehicle frame, a powertrain, and at least one refurbished axle assembly as described herein. The commercial vehicle further includes a steering control system, a service brake system, and an electronic control architecture with at least one controller configured to operate the ABS, the TCS, the speed monitoring system, and the all-wheel steering system in coordinated fashion during vehicle operation. Example embodiments include refuse-collection vehicles, utility service trucks equipped with aerial lifts, tow-and-recovery vehicles, snow-removal vehicles with front-mounted plows, and concrete-delivery trucks with rotating mixer drums. Application-specific steering profiles and control strategies may be implemented for these niches.

It is an object of the disclosed method, assembly and vehicle to provide a method of refurbishing surplus military and civilian drive axles so that they can be repurposed for use on commercial vehicles while meeting modern performance, durability, and safety standards.

A further object of the disclosed method, assembly, and vehicle is to increase maneuverability of heavy-duty commercial vehicles by converting fixed military drive axles into steerable axle assemblies and integrating them into all-wheel steering systems capable of crab steering and operator-controlled rear steering.

A further object of the disclosed method, assembly, and vehicle is to integrate refurbished axles with contemporary brake and stability systems by providing disc brake assemblies, anti-lock braking systems (ABS), traction control systems (TCS), and speed-dependent rear-steer locking to enhance vehicle control under varying load and road conditions.

A further object of the disclosed method, assembly, and vehicle is to enable application-specific steering behavior for different commercial niches, including refuse-collection trucks, utility service trucks with aerial lifts, tow-and-recovery vehicles, snow-removal vehicles, and concrete-delivery trucks, through configurable electronic control architectures and stored steering profiles.

A further object of the disclosed method, assembly, and vehicle is to reduce lifecycle cost and waste by reusing robust surplus military axle hardware, while adapting mounting interfaces, gear ratios, corrosion protection, and wheel hubs so the refurbished axle assemblies are compatible with widely available commercial vehicle components.

### BRIEF DESCRIPTION OF THE DRAWINGS

FIG. 1 is a perspective view of an embodiment of a surplus military drive axle prior to refurbishment, showing an axle housing, a differential housing, fixed drive ends, and wheel hubs configured for a military-grade vehicle;

FIG. 2 is a perspective view of an embodiment of a refurbished axle assembly adapted for commercial use, showing steerable ends replacing the fixed drive ends, steering knuckles mounted for rotation about pivot axes, disc brake assemblies at wheel ends, and mounting points for steering actuators;

FIG. 3 is a perspective view of an embodiment of a commercial vehicle equipped with a refurbished axle assembly, illustrating a portion of the vehicle frame, the refurbished axle mounted to the frame, a powertrain and driveline coupled to the axle, and a steering control system linking a steering wheel to the steerable ends;

FIG. 4 is a schematic block diagram of an electronic control architecture, including an anti-lock braking system (ABS), a traction control system (TCS), a speed monitoring system, an all-wheel steering control unit, wheel-speed sensors, a vehicle-speed sensor, and an electronic control unit (ECU) configured to coordinate operation of these systems;

FIG. 5 is a plan view of an embodiment of a commercial vehicle in a crab steering mode, showing front and rear wheels steered at substantially the same angle relative to a longitudinal axis of the vehicle to facilitate lateral movement in confined spaces;

FIG. 6 is a bottom view of an embodiment of a commercial vehicle in an operator-controlled rear steering mode, showing front wheels steered through a first angle and rear wheels independently steered through a second angle to reduce turning radius during low-speed maneuvers;

FIG. 7 is a plan view illustration of an embodiment of a refuse-collection vehicle incorporating the refurbished axle assembly, with arrows indicating a reduced turning radius for navigating alleys and cul-de-sacs;

FIG. 8 is a plan view illustration of a snow-removal vehicle equipped with a front-mounted plow and a rear steer axle, illustrating a tight low-speed turning maneuver executed while the plow is deployed; and

FIG. 9 is a top view of an embodiment of a concrete-delivery vehicle having a rotating mixer drum, illustrating the location of the refurbished axle assembly relative to a projected lateral stability envelope during a low-speed turning maneuver.

### DETAILED DESCRIPTION OF THE PREFERRED EMBODIMENTS

The following description is merely exemplary in nature and does not limit the present teachings, application, or uses. Throughout this specification, reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings.

The drawings furnished are intended to illustrate and plainly disclose presently envisioned embodiments to one of skill in the art but are not intended to be manufacturing level drawings or renditions of final products and may include simplified conceptual views to facilitate understanding or explanation. Also, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, steps, operations, elements, and/or components, but do not preclude the presence or addition of one or more other features, steps, operations, elements, components, and/or groups thereof.

The method steps, processes, and operations described herein are not to be construed as necessarily requiring their performance in the order discussed or illustrated, unless specifically identified as an order of performance. It is also understood that additional or alternative steps can be employed.

When an element, object, device, module, apparatus, component, region or section, etc., is referred to as being “on”, “engaged to or with”, “connected to or with”, or “coupled to or with” another element, object, device, module, apparatus, component, region or section, etc., it can be directly on, engaged, connected or coupled to or with the other element, object, device, module, apparatus, component, region or section, etc., or intervening elements, objects, devices, modules, apparatuses, components, regions or sections, etc., can be present.

In contrast, when an element, object, device, module, apparatus, component, region or section, etc., is referred to as being “directly on”, “directly engaged to”, “directly connected to”, or “directly coupled to” another element, object, device, module, apparatus, component, region or section, etc., there may be no intervening elements, objects, devices, modules, apparatuses, components, regions or sections, etc., present. Other words used to describe the relationship between elements, objects, devices, modules, apparatuses, components, regions, or sections, etc., should be interpreted in a like fashion (e.g., “between” versus “directly between,” “adjacent” versus “directly adjacent,” etc.).

As used herein, the term “and/or” includes all combinations of one or more of the associated listed items. For example, A and/or B includes A alone, or B alone, or both A and B. Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching may be used throughout the figures to denote different parts but not necessarily to denote the same or different materials.

Although the terms first, second, third, etc., can be used herein to describe various elements, objects, devices, modules, apparatuses, components, regions, or sections, etc., these elements, objects, devices, modules, apparatuses, components, regions, etc., should not be limited by these terms. These terms may be used only to distinguish one element, object, device, module, apparatus, component, region, or section, etc., from another element, object, device, module, apparatus, component, region, or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because varying and different embodiments may be made within the scope of the concept(s) taught herein, and because many modifications may be made in the embodiments described herein, it is to be understood that the details herein are to be interpreted as illustrative and non-limiting

As used herein, a “military-grade vehicle” refers to a vehicle configured for military service use and/or designed for operation under heavy-duty duty cycles, including high load capacity and harsh operating environments (e.g., off-road operation, exposure to water/mud/debris, temperature extremes, and sustained heavy loading). Military-grade vehicles include, by way of non-limiting example, tactical trucks, transport vehicles, and other military service vehicles. In some embodiments, a military-grade vehicle may be manufactured or modified to comply with one or more military procurement specifications or standards, although such compliance is not required.

As used herein, a “surplus military drive axle” refers to a drive axle assembly that was originally manufactured, configured, or specified for military use (including for a military-grade vehicle platform and/or to meet military procurement requirements), and that is thereafter available for reuse outside of military service.

A surplus military drive axle may have been deployed in military service, stored in inventory, or transferred to non-military use, and in some embodiments may have been installed and operated in a commercial or civilian vehicle prior to the refurbishment and conversion operations described herein. Intervening commercial use does not exclude an axle from being considered a surplus military drive axle so long as the axle was originally intended for military use.

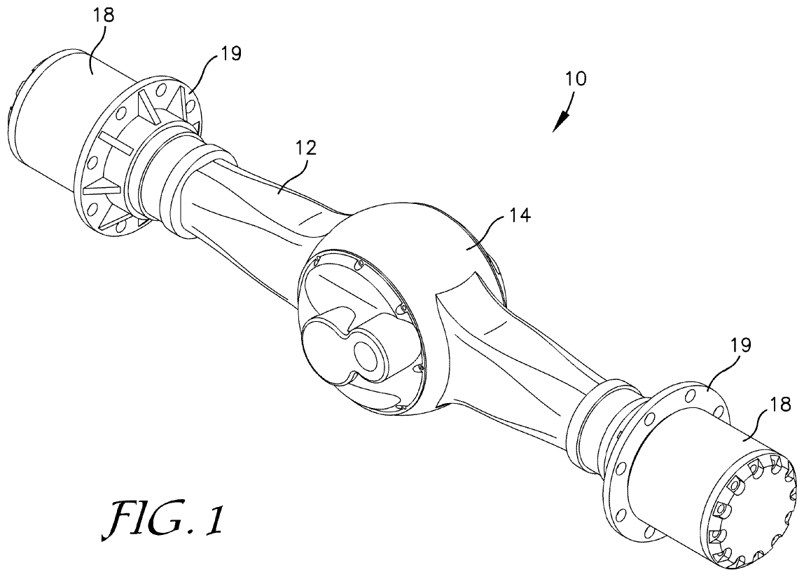

Referring now to FIG. 1, a surplus military drive axle 10 includes an axle housing 12, a differential housing 14, axle shafts (not shown), fixed drive ends 18, and wheel hubs 19 configured for use on a military-grade vehicle. The axle 10 is typically designed to support high loads and operate in harsh environments but is not directly compatible with commercial vehicle mounting arrangements or steering systems. The axle 10 may be obtained from retired military or civilian vehicles or surplus inventory.

In accordance with one embodiment, a surplus military axle 10 is obtained and its structural integrity and wear of its components is assessed, including the axle housing 12, the differential housing 14, and bearing assemblies associated with the axle shafts and wheel hubs 19. The axle 10 is disassembled and individual components are inspected for wear, corrosion, cracking, and other defects. Components that fail inspection are repaired or replaced to satisfy commercial vehicle operational standards and applicable safety regulations.

The axle housing 12 and differential housing 14 may be machined, welded, or otherwise modified to fit the mounting systems of a target commercial vehicle. For example, brackets, spring seats, or suspension interfaces may be repositioned or replaced to match a desired wheelbase and vehicle frame geometry. In some cases, differential gearing within the housing 14 is reconfigured to achieve torque and gear ratios compatible with the intended performance profile of the commercial vehicle, such as highway-speed operation, off-road work, or mixed-use applications.

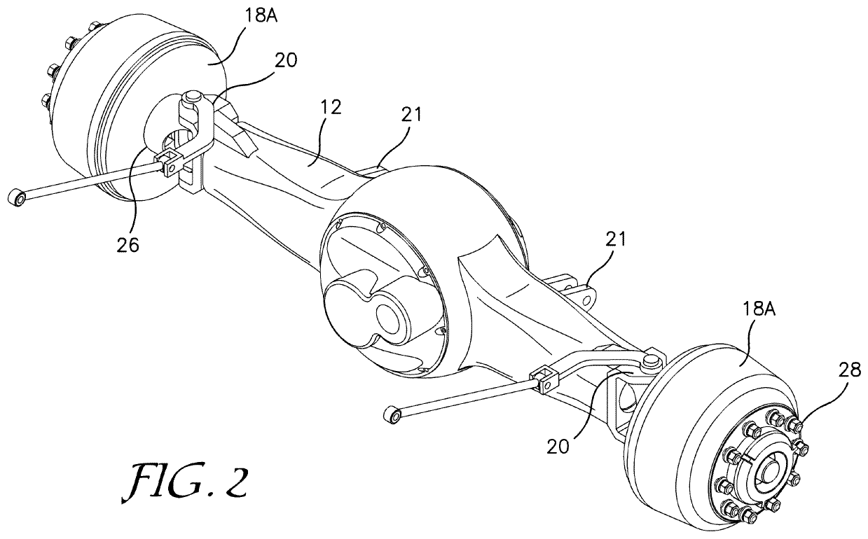

To convert the axle 10 from fixed drive ends to a pair of steerable ends 18A, the fixed drive ends 18 are removed, as illustrated in FIG. 2, from the axle housing 12. A load-distribution analysis is performed to ensure that the proposed steerable ends 18A are capable of supporting the weight of the commercial vehicle and any additional equipment mounted thereon. Based on this analysis, reinforcing structures (not shown) such as gussets or sleeves may be added to the axle housing 12. Mounting points 21 are formed on the axle housing 12 to receive steering knuckles 20 that define pivot axes 22 for steerable ends 24.

Each steering knuckle 20 is supported on the axle housing 12 by bearings or bushings 26 that facilitate smooth, low-friction rotation about the corresponding pivot axis 22. Wheel hubs 28 are mounted to the steerable ends 18A and are configured to receive standard commercial vehicle wheels (not shown) having a selected bolt circle diameter and offset. The hub configuration allows the refurbished axle assembly 10 to accept commonly available wheels and tires, simplifying maintenance and replacement in commercial service.

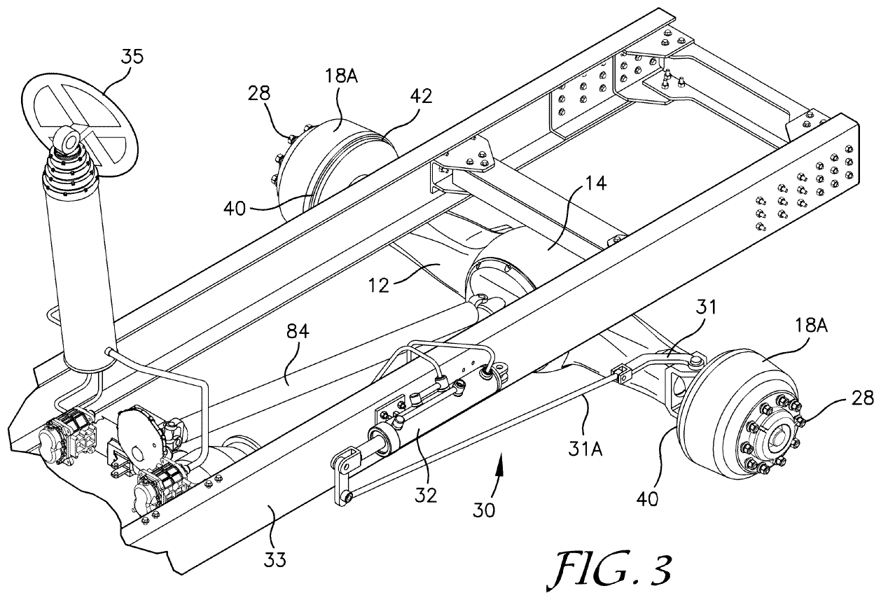

As illustrated at FIG. 3, a steering mechanism 30 is provided to link the steerable ends 18A to a steering control system of the commercial vehicle. The steering mechanism 30 may include one or more steering arms 31, tie rods 31A, or drag links connected to a steering gear. In some embodiments, the steering control system includes a rack-and-pinion steering system, while in other embodiments it may include a hydraulic steering control system or an electric or electro-hydraulic steering control system. At least one steering hydraulic cylinder or steering actuator 32 is installed and aligned with the steering mechanism 30 to generate steering motion of the steerable ends 18A. The steering actuators 32 may be mounted directly to the axle housing 12 or to adjacent frame structures 33 depending on the vehicle configuration.

The steering control system is integrated with the refurbished axle assembly such that an operator at a driver position can command steering of the steerable ends 24 using a conventional steering wheel 35 or other control interface. The steering geometry, including tie-rod lengths and steering arm orientations, is selected to achieve desired Ackermann steering geometry and turning radii appropriate for the target commercial application. Steering linkages and suspension components are aligned to avoid uneven tire wear, excessive bump steer, and poor handling characteristics.

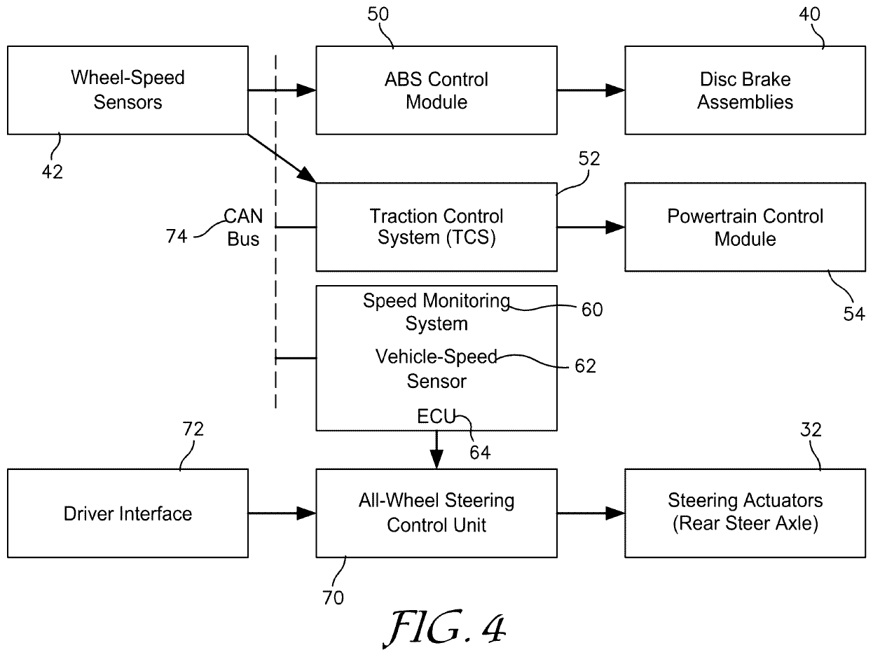

As detailed at FIG. 4, disc brake assemblies 40, preferably are mounted at the wheel hubs 28 of the steerable ends 18A. Each disc brake assembly 40 may be hydraulically or optionally pneumatically actuated using a compressed-air system of the commercial vehicle. Wheel-speed sensors 42 are associated with the disc brake assemblies 40 or the wheel hubs 28 and provide rotational speed information for each wheel. An ABS control module 50 receives signals from the wheel-speed sensors 42 and commands selective brake application or release to prevent excessive wheel slip during braking events. The refurbished axle assembly may be integrated into an existing ABS of the commercial vehicle or may be provided with a dedicated ABS module.

As further detailed at FIG. 4, a TCS 52 is coupled to the ABS control module 50 and to a powertrain control module of the vehicle. The TCS 52 monitors wheel-speed data and determines when drive wheel slip exceeds one or more thresholds. In response, the TCS 52 may command the ABS control module 50 to selectively apply braking to one or more wheels and may also instruct the powertrain control module to reduce engine torque. The TCS 52 thereby cooperates with the ABS to improve traction and vehicle stability under low-friction or uneven load conditions.

The traction control system (TCS) 52 may be implemented as a dedicated electronic control module or as software resident in an integrated brake/vehicle dynamics controller. In operation, TCS 52 receives wheel-speed information from the wheel-speed sensors 42, as well as additional data such as engine torque demand, throttle position, brake pressure, and transmission gear state. When TCS 52 detects excessive drive-wheel slip relative to a desired slip target, for example during acceleration on low friction surfaces or while towing a heavy load, it generates command signals to modulate brake pressure at one or more of the disc brake assemblies 40 via the ABS control module 50 and/or to request torque reduction from the powertrain control module 54.

The control logic can include proportional-integral-derivative (PID) regulators, slip-ratio based control maps, and vehicle-state observers that account for axle load transfer and steering angle so that traction is maintained without creating instability or excessive driveline shock. In some embodiments, TCS 52 also exchanges information with the all-wheel steering control unit 70 so that rear-steer authority can be reduced under conditions of low friction or high lateral acceleration, further enhancing stability.

Commercially available heavy-duty traction control systems suitable for implementation of TCS 52 are offered by several established suppliers to the truck and bus markets. By way of non-limiting example, Bendix Commercial Vehicle Systems provides electronic stability and traction control functionality through its ESP/ATC platforms for air-braked vehicles, which integrate closely with ABS hardware and wheel-speed sensors. WABCO (now part of ZF Group) offers similar traction and stability functions in its modular braking and vehicle dynamics control systems used on commercial trucks, buses, and trailers. Other suppliers, such as Meritor (for axle and brake integration), Knorr-Bremse, and Bosch, provide TCS features as part of their electronic braking and stability control product lines for heavy vehicles.

These commercially available systems typically employ architectures and algorithms consistent with the TCS 52 described herein; in some embodiments, the TCS 52 may comprise a configured instance of such a commercial system, or may be implemented as custom software executed on a generic electronic control unit using industry-standard communication buses such as CAN. The CAN digital communication system 74 lets multiple electronic control units (ECUs) talk to each other over two wires instead of each ECU needing its own dedicated wiring to every other module.

The speed monitoring system 60 includes a vehicle-speed sensor 62 and an electronic control unit (ECU) 64. When the vehicle speed exceeds a designated road-speed threshold, the speed monitoring system 60 automatically commands the rear steer axle to transition from a steering mode to a centered and locked mode. The speed monitoring system 60 can use one or more sources of speed to include a transmission output speed sensor, wheel speed sensors, a driveline speed sensor and in some cases GPS-based speed as a back up or supplement.

The speed monitoring system 60 then feeds that speed data into the ECU 64, which filters the signal (debouncing, averaging), compares it to thresholds (e.g., 15 mph for rear-steer lockout, 5 mph for enabling tight-turn profile) and sets “state flags,” e.g., rear steer allowed, true/false, highway mode, true/false, etc. Next, appropriate commands are sent to the all-wheel steering control unit 70, the steering actuators 32 and possibly the traction control system (TCS) 52 to provide for changes in traction and brake behavior at higher speeds.

In one embodiment, the ECU 64 comprises an automotive-grade electronic control unit including at least one microprocessor, memory storing control software and calibration data, input circuitry configured to receive signals from vehicle sensors and subordinate control modules, and output circuitry configured to transmit command messages to the ABS control module 50, the traction control system 52, the all-wheel steering control unit 70, and one or more steering actuators 32 to coordinate operation of these systems during vehicle operation.

An automotive-grade electronic control unit (ECU) 64, which may comprise a commercially available vehicle or chassis controller, can be supplied, for example, by Bosch, Continental, ZF, or other providers of electronic control systems for commercial vehicles and off-highway equipment.

The vehicle-speed sensor 62 may be integrated with a transmission output shaft, a wheel-speed sensor, or a global navigation satellite system (GNSS) receiver. The ECU 64 receives vehicle-speed information and is configured to automatically transition a rear steer axle from a steering mode to a centered and locked mode when vehicle speed exceeds a designated road speed.

The designated road speed may be fixed for a given application or may be programmable by a technician or operator. When the speed threshold is exceeded, the ECU 64 commands the steering actuators 32 associated with the rear steer axle to return the steerable ends 24 to a centered position and engage one or more locking mechanisms that prevent further steering movement until vehicle speed is reduced below the threshold.

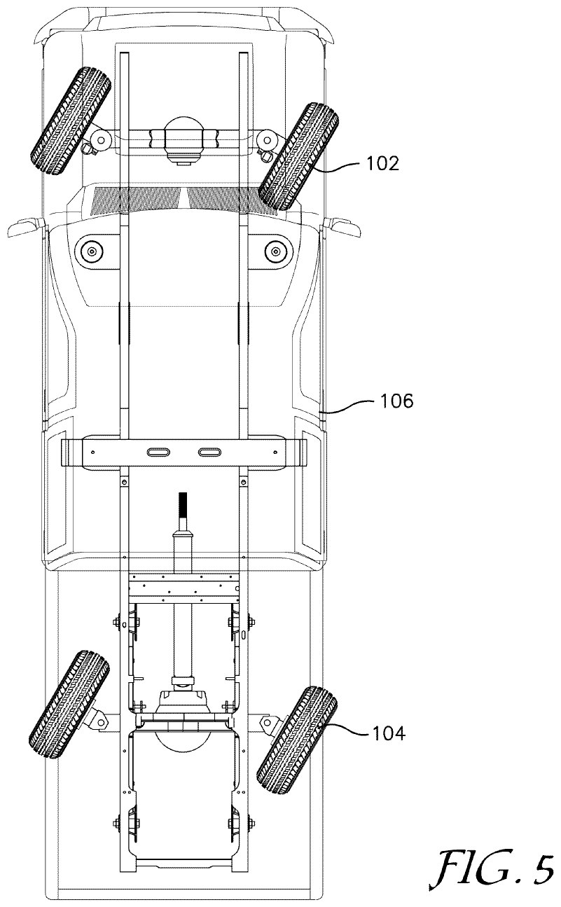

An all-wheel steering control unit 70 coordinates steering of a front axle and the refurbished rear steer axle. In crab steering mode, the control unit 70 commands the front and rear axles 102, 104 to steer in substantially the same angular direction relative to a longitudinal axis of the vehicle 106, as illustrated in FIG. 5. The all-wheel steering control unit 70 can be described as an electronic controller that coordinates front and rear steering angles to achieve specific maneuvering behaviors (e.g., conventional steering, crab steering, and counter-phase rear steering).

In one embodiment, the control unit 70 receives inputs from the driver interface 72 (mode selection, steering-profile selection), a steering-wheel angle sensor, vehicle-speed signals from the speed monitoring system 60, and possibly additional signals such as lateral acceleration or yaw rate. Based on these inputs and one or more stored steering profiles, the control unit 70 calculates a commanded rear steering angle as a function of front steering angle and vehicle speed.

At very low speeds, the control unit may command relatively large rear-steer angles, either in phase (crab) or counter-phase (tight turning radius), while at higher speeds it progressively limits or disables rear steering to preserve stability. The control unit 70 then outputs actuator commands to the steering actuators 32 (hydraulic or electro-mechanical) on the rear axle and may also send diagnostic and status information back to the ECU 64 and driver displays.

In some implementations, the all-wheel steering control unit 70 can store multiple application-specific steering maps, for example a “yard maneuver” profile with aggressive rear-steer authority, a “city” profile with moderate authority and tighter speed limits, and a “highway” profile in which rear steering is limited or locked out.

The control unit may also enforce interlocks based on payload, plow deployment, or other configuration signals, so that rear steering is restricted when stability margins must be maximized (e.g., aerial lift extended, concrete drum full, or vehicle towing a heavy load). Diagnostic functions may include monitoring actuator position sensors, hydraulic pressures, and communication integrity on the vehicle network, with the control unit 70 capable of transitioning to a safe centered-axle state upon detection of a fault.

All-wheel steering functions of this type can be implemented using commercial steering and vehicle-dynamics controllers from established suppliers. For example, ZF offers rear-axle steering and active steering systems for commercial vehicles and buses as part of its commercial vehicle steering portfolio (including the ReAX/AKC families in some applications). Bosch and Continental supply electronic control units and software for integrated chassis control and rear-wheel steering in various on-road vehicle platforms, which can be adapted or configured for heavy-duty multi-axle vehicles.

Likewise, steering-system specialists such as Parker Hannifin and Danfoss Power Solutions provide electro-hydraulic steering controllers and valve modules designed for off-highway and specialty vehicles (e.g., refuse trucks, agricultural machines, and construction equipment) that support coordinated front and rear-axle steering. In some embodiments, the all-wheel steering control unit 70 may be realized as a configured instance of such a commercial controller, while in other embodiments it may be implemented as custom software running on a generic automotive-grade ECU communicating over a CAN or similar vehicle network.

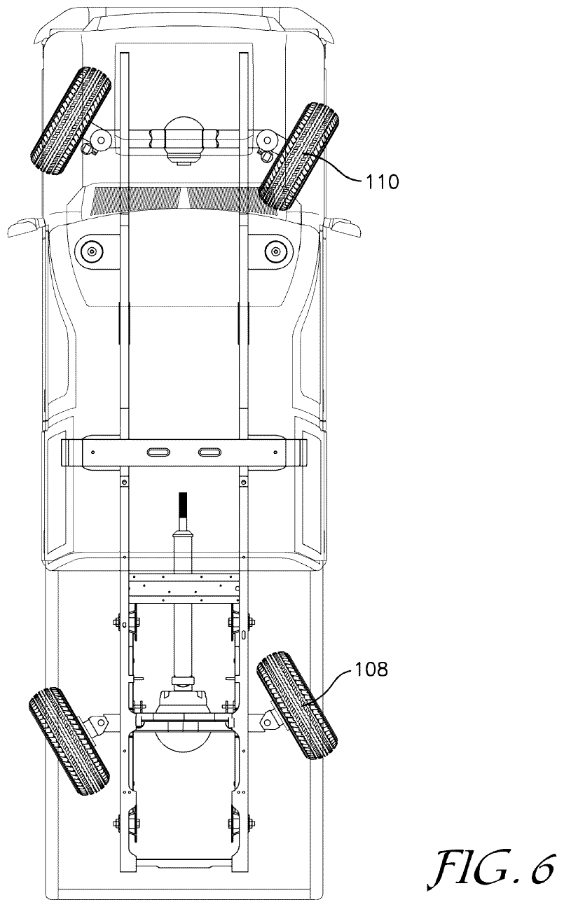

The crab steering mode facilitates lateral movement and lane changes in confined spaces. In an operator-controlled rear steering mode, a driver interface 72 allows the operator to independently adjust a rear wheel steering angle relative to a front axle steering angle as illustrated at FIG. 5. This mode can significantly reduce turning radius during low-speed maneuvers such as backing into loading docks or navigating tight job sites. A rear steer option 108 counter to the front wheel steer 110 is illustrated at FIG. 6.

The all-wheel steering control unit 70 may store a plurality of application-specific steering profiles. Each profile may define relationships between front and rear steering angles, speed-dependent limitations on rear steer authority, and transitions between steering modes. Profiles may be selected based on operator input, vehicle configuration parameters, or detected operating conditions. For example, different steering profiles may be used for on-road driving, off-road operation, and yard maneuvers.

After mechanical and control-system modifications are complete, the refurbished axle assembly 10 is reassembled with refurbished or replaced components. The axle shafts may be dynamically balanced to reduce vibration during operation and to improve bearing life. The axle housing 12 and associated brackets and components are cleaned and coated with a corrosion-resistant finish such as a high-durability powder coating formulated to resist deicing chemicals, moisture, and abrasion typically encountered in commercial vehicle service.

Validation testing may be conducted on the refurbished axle assembly and the vehicle into which it is installed. In some embodiments, validation testing includes verifying steering function and range of motion of each steerable end, confirming proper bearing/bushing support at the pivot axes, and checking that toe, camber, and steering return-to-center characteristics fall within specified tolerances. Validation testing may further include brake-system verification (e.g., braking balance, ABS sensor operation where present), leak and seal integrity checks, and load-based testing to confirm the axle housing and knuckle interfaces maintain structural integrity under expected commercial duty cycles.

Test results may be used to confirm compliance with applicable commercial vehicle safety regulations and to adjust control strategies, steering geometries, or component selections. A maintenance schedule may be established specifying periodic inspection of steering components, bushings, bearings, suspension alignment, and brake and sensor systems associated with the refurbished axle assembly.

In one apparatus embodiment, the refurbished axle assembly includes the reworked axle housing 12, the differential housing 14 with reconfigured gearing, the steerable ends 24 with steering knuckles 20 and bearings or bushings 26, the steering mechanism 30, the steering actuators 32, the disc brake assemblies 40, wheel-speed sensors 42, the ABS control module 50, the TCS 52, the speed monitoring system 60, the all-wheel steering control unit 70, and the corrosion-resistant finish. The wheel hubs 28 are configured to receive standard commercial vehicle wheels, and the axle shafts are dynamically balanced. This axle assembly can be provided as a retrofit component for installation on existing commercial trucks or as original equipment for new vehicle builds.

In a vehicle embodiment, as best illustrated at FIG. 3, a commercial vehicle includes a vehicle frame 33, a powertrain, a driveline 84, and at least one refurbished axle assembly 10 mounted to the frame 33 and coupled to the driveline 84. A steering control system 32 is operably coupled to the refurbished axle assembly 10, and a service brake system is operably coupled to the disc brake assemblies 40 and the ABS control module 50. An electronic control architecture including the ECU 64, the ABS module 50, the TCS 52, and the all-wheel steering control unit 70 coordinates operation of these subsystems during vehicle operation.

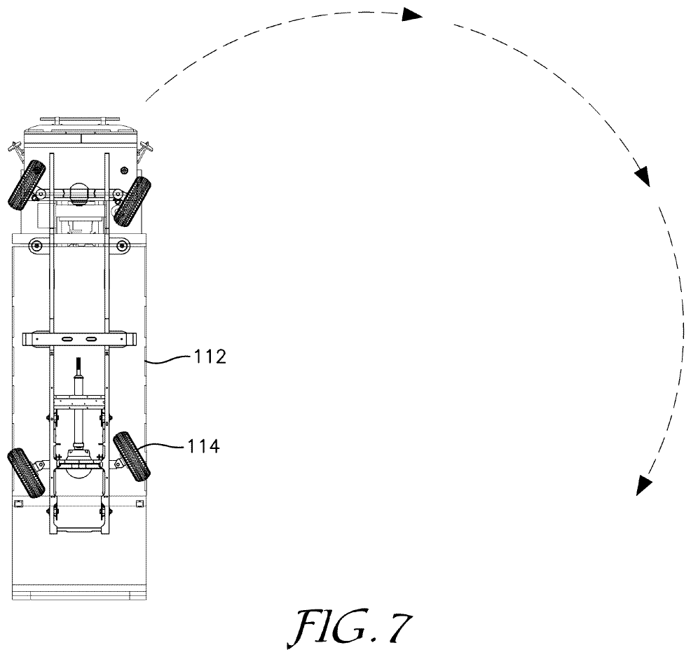

In one niche embodiment, the commercial vehicle 112 is a refuse-collection vehicle as illustrated at FIG. 7. The all-wheel steering system is calibrated to provide a reduced turning radius at low speeds appropriate for stop-and-go operation in urban environments. The speed monitoring system 60 may be configured to employ a relatively low designated road speed threshold so that the rear steer axle 114 remains active at typical collection speeds but is automatically centered and locked when the vehicle accelerates between collection stops or travels along arterial roadways.

In another niche embodiment, the commercial vehicle is a utility service truck equipped with an aerial lift and outrigger stabilizers (not shown). This enhances vehicle stability when the aerial lift is raised and workers are positioned in an elevated bucket or platform.

In a further niche embodiment, the commercial vehicle is a tow-and-recovery vehicle configured to tow a disabled vehicle (not shown). The TCS 52 is configured to adjust wheel slip thresholds based on a towed load parameter indicative of the weight of the towed vehicle. The towed load parameter may be derived from hydraulic pressure sensors associated with a boom or wheel-lift, from strain sensors, or from operator input. By adjusting slip thresholds, the TCS 52 can improve traction and vehicle stability under uneven load conditions encountered during towing operations.

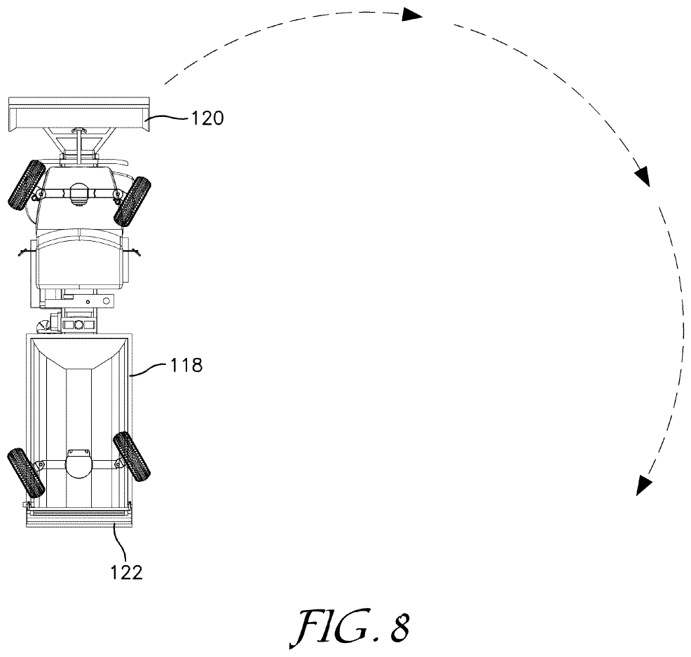

In yet another niche embodiment, the commercial vehicle is a snow-removal vehicle 118 equipped with a front-mounted plow 120 and optionally a rear-mounted salt spreader 122 as illustrated at FIG. 8. The all-wheel steering system is configured to provide increased rear-steer angles at low speeds to maintain maneuverability with the plow 120 extended in front of the vehicle 118. The speed monitoring system 60 and the electronic control architecture progressively reduce rear-steer authority as vehicle speed increases while the plow is deployed, thereby improving high-speed stability during plowing operations along roadways.

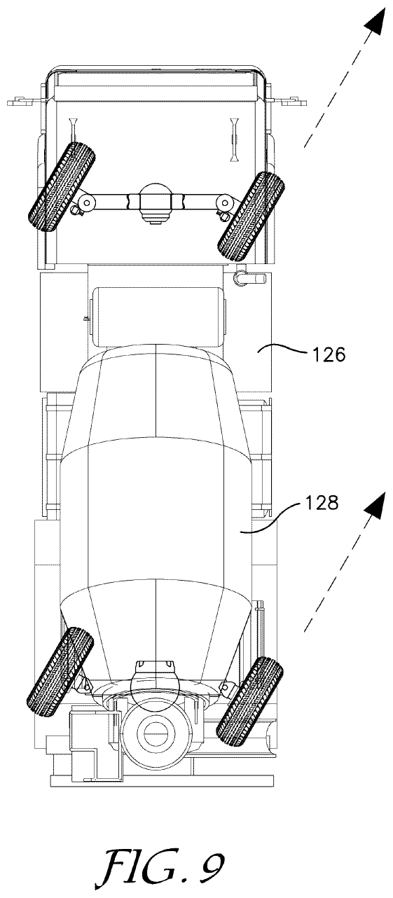

In another niche embodiment as illustrated at FIG. 9, the commercial vehicle 126 is a concrete-delivery vehicle having a rotating mixer drum 128 mounted on the vehicle frame. The all-wheel steering system is configured to coordinate steering such that a center of mass associated with the vehicle 126 and the mixer drum 128 remains within a defined lateral stability envelope during low-speed turning maneuvers at job sites. The lateral stability envelope may be determined based on vehicle geometry, drum capacity, and expected load conditions, and may be stored as part of an application-specific steering profile.

In some embodiments, the electronic control architecture preferably stores a plurality of application-specific steering profiles respectively associated with at least two commercial vehicle niches, such as refuse-collection trucks, utility service trucks with aerial lifts, tow-and-recovery vehicles, snow-removal vehicles, and concrete-delivery trucks. An operator or technician may select a desired profile via a driver interface 72 or a service tool. The selected profile governs relationships between front and rear steering angles, rear-steer authority as a function of speed, and transitions between steering modes to optimize performance and safety for the particular commercial application.

The disclosure presented herein is believed to encompass at least one distinct invention with independent utility. While at least one invention has been disclosed in exemplary forms, the specific embodiments thereof as described and illustrated herein are not to be considered in a limiting sense, as numerous variations are possible. Equivalent changes, modifications, and variations of the variety of embodiments, materials, compositions, and methods may be made within the scope of the present disclosure, achieving substantially similar results. The subject matter of the invention includes all novel and non-obvious combinations and sub-combinations of the various elements, features, functions and/or properties disclosed herein and their equivalents.

Benefits, other advantages, and solutions to problems have been described herein regarding specific embodiments. However, the benefits, advantages, solutions to problems, and any element or combination of elements that may cause any benefits, advantage, or solution to occur or become more pronounced are not to be considered as critical, required, or essential features or elements of any or all the claims of at least one invention.

Many changes and modifications within the scope of the instant disclosure may be made without departing from the spirit thereof, and the one or more inventions described herein include all such modifications. Corresponding structures, materials, acts, and equivalents of all elements in the claims are intended to include any structure, material, or acts for performing the functions in combination with other claim elements as specifically recited. The scope of the one or more inventions should be determined by the appended claims and their legal equivalents, rather than by the examples set forth herein.

Benefits, other advantages, and solutions to problems have been described herein regarding specific embodiments. Furthermore, the connecting lines, if any, shown in the various figures contained herein are intended to represent exemplary functional relationships and/or physical couplings between the various elements. It should be noted that many alternative or additional functional relationships or physical connections may be present in a practical system.

However, the benefits, advantages, solutions to problems, and any elements that may cause any benefit, advantage, or solution to occur or become more pronounced are not to be construed as critical, required, or essential features or elements of the inventions.

In the detailed description herein, references to “one embodiment,” “an embodiment,” “an example embodiment,” etc., indicate that the embodiment described may include a feature, structure, or characteristic, but every embodiment may not necessarily include the feature, structure, or characteristic. Moreover, such phrases are not necessarily referring to the same embodiment. Further, when a feature, structure, or characteristic is described relating to an embodiment, it is submitted that it is within the knowledge of one skilled in the art to affect such feature, structure, or characteristic relating to other embodiments whether explicitly described.

After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element herein is to be construed under the provisions of 35 U.S.C. § 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The method steps described in this disclosure, if any, are not intended to be limited to the specific order presented in the claims. While the steps may be described sequentially for clarity, it is understood that the order of the steps may be altered or rearranged without departing from the scope of the invention. The method is intended to be flexible in its application, allowing for variations in the sequence of steps based on specific implementation requirements, processing capabilities, or other considerations.

As such, the invention encompasses all orders of execution for the steps, provided the desired result or function of the invention is achieved. The disclosed system and method have been described above with reference to one or more preferred embodiments, it will be appreciated that various changes or modifications may be made without departing from the scope of the invention as defined in the appended claims.

1. A method of converting a surplus military drive axle for use on a commercial vehicle, comprising:
obtaining a surplus military drive axle originally configured for a military-grade vehicle, the surplus military drive axle including an axle housing, a differential, axle shafts, and fixed drive ends;
disassembling the surplus military drive axle and inspecting components for wear or damage;
repairing or replacing one or more components to satisfy commercial vehicle operational standards;
modifying at least one of (i) the axle housing or (ii) the differential to interface with a mounting system of the commercial vehicle;
removing the fixed drive ends from the axle housing;
forming or modifying mounting points on the axle housing to receive steering knuckles that define respective pivot axes;
installing the steering knuckles on the axle housing such that each steering knuckle is supported for rotation about a corresponding pivot axis by at least one bearing or bushing;
providing a steerable driven wheel end at each steering knuckle that is coupled to a corresponding axle shaft to receive drive torque from the differential;
adapting or replacing a wheel hub assembly at each steerable driven wheel end such that each wheel hub assembly presents a commercially compatible wheel mounting interface having a selected bolt circle diameter and a selected offset for mounting a standard commercial vehicle wheel;
mechanically coupling a steering mechanism to the steerable driven wheel ends to rotate the steerable driven wheel ends about the pivot axes;
installing at least one steering actuator arranged to impart steering motion to the steering mechanism;
reassembling the drive axle as a refurbished steerable drive axle assembly; and
applying a corrosion-resistant finish to at least a portion of the axle housing.

2. The method of claim 1, wherein adapting the wheel hub assembly comprises modifying or replacing one or more hub-related components such that the axle assembly accepts the standard commercial vehicle wheels without a wheel adapter.

3. The method of claim 2, wherein the step of modifying further comprises mounting disc brake assemblies at wheel ends of the steerable driven wheel end assemblies, coupling an anti-lock braking system (ABS) to the disc brake assemblies, the ABS including wheel-speed sensors associated with the refurbished steerable drive axle assembly, and providing a traction control system (TCS) coupled to the ABS and configured to selectively apply braking to control wheel slip.

4. The method of claim 2, wherein adapting the wheel hub assembly comprises selecting the bolt circle diameter as a diameter of a circle passing through centers of wheel mounting studs or bolt holes, and selecting the offset as an axial spacing between a wheel mounting surface and a wheel centerline, such that the commercially compatible wheel mounting interface matches a target commercial wheel specification.

5. The method of claim 1, wherein the corrosion-resistant finish comprises a high-durability powder coating formulated to resist deicing chemicals and high-moisture environments encountered in commercial vehicle service.

6. The method of claim 3, wherein the disc brakes are hydraulically actuated.

7. The method of claim 3, wherein the disc brakes are pneumatically actuated using a compressed-air system of the commercial vehicle.

8. The method of claim 1, wherein a steering control system comprises at least one of: (a) a rack-and-pinion steering system, (b) a hydraulic steering control system, or (c) an electric or electro-hydraulic steering control system.

9. The method of claim 1, wherein the steering mechanism comprises at least one of a steering arm, a steering knuckle, and a pair of tie rods mechanically linking the steerable ends to the steering control system.

10. The method of claim 3, wherein the traction control system (TCS) comprises:
wheel-speed sensors integrated into the axle assembly;
a control module configured to receive signals from the wheel-speed sensors and command selective brake application through the ABS; and
an interface with a powertrain control module configured to reduce engine torque when wheel slip is detected.

11. The method of claim 1, wherein installing a speed monitoring system comprises: providing a vehicle-speed input to an electronic control unit (ECU); and storing, in the ECU, control logic that, when the vehicle-speed input indicates vehicle speed at or above a predetermined highway-speed threshold, commands at least one steering actuator associated with a rear steer axle to return the steerable driven wheel end assemblies to a centered position and to engage a locking mechanism that inhibits further steering movement until vehicle speed is below the threshold.

12. The method of claim 11, wherein the predetermined highway-speed threshold is fixed or programmable depending on intended use of the commercial vehicle.

13. The method of claim 1, wherein providing the all-wheel steering system comprises:
installing a steering control unit configured to coordinate steering angles of front and rear axles;
installing hydraulic actuators or electric motors at the rear steer axle to set rear wheel steering angles; and
integrating a driver interface configured to allow selection between at least a crab steering mode and an operator-controlled rear steering mode.

14. The method of claim 13, wherein:
in the crab steering mode, the front and rear axles are controlled to steer in a same angular direction relative to a longitudinal axis of the commercial vehicle; and
in the operator-controlled rear steering mode, the driver interface allows independent manual adjustment of the rear wheel steering angle relative to the front axle steering angle.

15. The method of claim 1, further comprising conducting post-conversion validation testing, including at least one of:
steering response testing under load, brake performance testing at different vehicle speeds, and
lane-change stability testing at highway speeds, to confirm compliance with applicable commercial vehicle safety regulations.

16. The method of claim 1, further comprising establishing a maintenance schedule specifying periodic inspection of steering components, bushings, bearings, and suspension alignment of the refurbished axle once installed on the commercial vehicle.

17. The method of claim 1, wherein converting the axle from fixed drive ends to a pair of steerable ends comprises:
(a) removing each fixed drive end of the axle;
(b) performing a load-distribution analysis to ensure the steerable ends are capable of supporting weight of the commercial vehicle and determining whether structural reinforcements are required;
(c) installing a steering mechanism configured to connect the axle to a steering control system of the commercial vehicle;
(d) installing at least one steering hydraulic cylinder or steering actuator and aligning the steering hydraulic cylinder or steering actuator with the steering mechanism to provide steering motion;
(e) modifying a plurality of mounting points on the axle to receive steering knuckles or pivots that allow the steerable ends to rotate about corresponding pivot axes; and
(f) installing additional bearings or bushings at the pivot axes to provide smooth, low-friction rotation of the steerable ends.

18. A refurbished axle assembly adapted from a surplus military drive axle for use on a commercial vehicle, comprising:
an axle housing originally configured for a military-grade vehicle, the axle housing having been reworked to interface with a mounting system of the commercial vehicle;
a differential housed within the axle housing and configured to deliver drive torque to opposed axle shafts;
a pair of steerable driven wheel end assemblies supported by the axle housing and coupled to corresponding ones of the axle shafts, each steerable driven wheel end assembly comprising:
(a) a steering knuckle mounted to the axle housing for rotation about a pivot axis;
(b) at least one bearing or bushing supporting the steering knuckle for rotation about the pivot axis;
(c) a wheel hub coupled to the steering knuckle and defining a wheel mounting interface configured to mount a standard commercial vehicle wheel, the wheel mounting interface having a selected bolt circle diameter and a selected offset; and
(d) a steering linkage connection feature configured to couple the steering knuckle to a steering mechanism;
a steering mechanism coupled to the steerable driven wheel end assemblies and operable to rotate the steerable driven wheel end assemblies about the pivot axes;
at least one steering actuator operably coupled to the steering mechanism to generate steering motion of the steerable driven wheel end assemblies; and
a corrosion-resistant finish applied to at least a portion of the axle housing.

19. The refurbished axle assembly of claim 18, wherein the assembly further comprises disc brake assemblies mounted at wheel ends of the steerable ends and an anti-lock braking system (ABS) coupled to the disc brake assemblies, the ABS including wheel-speed sensors associated with the axle assembly.

20. The refurbished axle assembly of claim 19, wherein the assembly further comprising a traction control system (TCS) coupled to the ABS and configured to command at least one of braking and engine torque to control wheel slip.

21. A commercial vehicle, comprising:
a chassis;
a refurbished steerable drive axle assembly mounted to the chassis, the refurbished steerable drive axle assembly comprising:
an axle housing originally configured for a military-grade vehicle, the axle housing including at least one modified interface feature adapted to couple the axle housing to a mounting system of the commercial vehicle;
a differential supported by the axle housing;
opposed axle shafts coupled to the differential to deliver drive torque to wheel ends of the axle assembly;
a pair of steerable driven wheel end assemblies supported by the axle housing, each steerable driven wheel end assembly comprising:
a steering knuckle mounted to the axle housing for rotation about a pivot axis;
at least one bearing or bushing supporting the steering knuckle for rotation about the pivot axis;
a wheel hub coupled to the steering knuckle and defining a wheel mounting interface configured to mount a standard commercial vehicle wheel, the wheel mounting interface having a selected bolt circle diameter and a selected offset; and
a steering linkage connection feature configured to couple the steering knuckle to a steering mechanism;
a steering mechanism coupled to the steerable driven wheel end assemblies and operable to rotate the steerable driven wheel end assemblies about the pivot axes; and
a corrosion-resistant finish applied to at least a portion of the axle housing; and
at least one steering actuator operably coupled to the steering mechanism to generate steering motion of the steerable driven wheel end assemblies, wherein the steering actuator is controlled by an electronic control unit configured to coordinate steering of front and rear axles.

22. The commercial vehicle of claim 21, wherein the vehicle includes a speed monitoring system configured to receive vehicle-speed information and automatically transition the rear axle assembly to a centered-and-locked mode at or above a designated road speed wherein the electronic control unit is further configured to command the steering actuator to return the steering knuckle to a centered position and engage a locking mechanism that inhibits further steering movement above the designated road speed.

23. The commercial vehicle of claim 21, wherein the vehicle includes an all-wheel steering control unit configured to coordinate steering angles of the front axle and the rear axle assembly and to provide (i) a crab steering mode and (ii) an operator-controlled rear steering mode, wherein in the crab steering mode the front and rear axles are steered in a same angular direction relative to a longitudinal axis of the vehicle, and wherein in the operator-controlled rear steering mode rear wheel steering angle is independently adjustable relative to front wheel steering angle.

24. The commercial vehicle of claim 21, wherein the commercial vehicle comprises a refuse-collection vehicle configured for repeated stop-and-go operation in urban environments, and wherein the all-wheel steering system is calibrated to provide a reduced turning radius at low speeds to facilitate navigation of narrow alleys and cul-de-sacs, and wherein rear steering authority is progressively reduced as vehicle speed increases.

25. The commercial vehicle of claim 21, wherein an electronic control architecture is configured to store a plurality of application-specific steering profiles selected from refuse-collection trucks, utility service trucks with aerial lifts, tow-and-recovery vehicles, snow-removal vehicles, and concrete-delivery trucks, and to select a corresponding steering profile based on an operator input or a vehicle configuration parameter, wherein each steering profile defines a relationship between vehicle speed and rear steering angle authority.

26. A refurbished steerable drive axle assembly adapted from a surplus military drive axle for use on a commercial vehicle, comprising:
an axle housing originally configured for a military-grade vehicle and including at least one modified interface feature adapted to couple the axle housing to a mounting system of the commercial vehicle;
a differential supported by the axle housing;
opposed axle shafts coupled to the differential to deliver drive torque to wheel ends of the axle assembly; and
at least one steerable driven wheel end assembly coupled to a corresponding one of the axle shafts and supported by the axle housing, the steerable driven wheel end assembly including:
a steering knuckle mounted to the axle housing for rotation about a pivot axis and supported by at least one bearing or bushing;
a wheel hub coupled to the steering knuckle and configured to mount a commercial vehicle wheel; and
a steering linkage connection feature configured to couple the steering knuckle to a steering mechanism to steer the steerable driven wheel end assembly about the pivot axis, wherein the axle housing further includes mounting structures configured to support steering actuators and associated control components for coordinated steering.

27. The refurbished steerable drive axle assembly of claim 26, further comprising a speed monitoring system including a vehicle-speed sensor and an electronic control unit (ECU) configured to receive vehicle-speed information and, when the vehicle speed is at or above a designated road-speed threshold, to command the at least one steering actuator to return the steering knuckle to a centered position and to engage at least one locking mechanism that prevents further steering movement until vehicle speed is below the threshold, wherein the ECU is further configured to disable or limit rear steering above the threshold to enhance high-speed stability.
